(19) United States
(12) Patent Application Publication
(10) Pub. No.: US 2013/0059040 A1
(43) Pub. Date: Mar. 7, 2013

(54) GRAB-AND-GO FOOD PRODUCTS AND METHODS OF MAKING SAME

(71) Applicant: Catherine Proper, Minneapolis, MN (US)

(72) Inventor: Catherine Proper, Minneapolis, MN (US)

(21) Appl. No.: 13/223,404

(22) Filed: Sep. 1, 2011

(51) Int. Cl. A23P 1/08; A23L 1/01; A23L 1/31

(52) U.S. Cl. 426/92; 426/94; 426/293

(57) ABSTRACT

The present disclosure relates to novel and advantageous food products comprising, a filling and a starch layer surrounding the filling. The food product also includes a batter and breading layer surrounding the starch layer, wherein the food product is cylindrically shaped, and wherein the food product maintains its shape when the food product is held.

### FIELD OF THE INVENTION

The present disclosure relates to novel and advantageous food products, such as filled sticks or bites and methods of making the same, which are packaged for a grab-and-go sales environment, and to a method for heating such products on a roller grill to an eating temperature without degrading the quality of the product.

### BACKGROUND OF THE INVENTION

The convenience store industry is a multi-billion dollar a year industry. Increasingly, convenience stores have become a quick, easy, and relatively cheap source for consumers to purchase grab-and-go food. For example, many convenience stores sell grab-and-go foods such as pizza, prepared sandwiches, hot dogs and/or brats. Hot dogs, brats or other like products may typically be cooked and/or warmed on a hot dog steamer, hot dog broiler, or hot dog roller grill. In the typical roller grill, a plurality of elongate cylindrical rods are mounted in parallel relationship so as to support an object, such as a hot dog, between the rods. The rods are heated to a desired temperature and continuously rotated. As the rods rotate, the hot dogs rotate in an opposite direction in the space created between the rods. As a result of the rotation, the hot dogs remain hot without becoming burned, as would be the case if they were heated on a grill without rotation.

More modern roller-type grills offer a variety of specialized features. For example, the front rollers may be heated to a first temperature with the back rollers heated to a second higher temperature (or vice versa). The front rollers may then be employed to heat a first food product that requires less heating than a second food product placed on the back rollers. More recently, such roller grill units have been utilized to heat food products other than hot dogs in a vending situation. For example, burrito products have been manufactured to roll on and be heated by a roller grill. Such other products, however, have not been very successful because of the relatively short product life experienced by such products.

Another problem with roller grills exists with the products themselves. In the case of non-hot dog products, heating the food product on a roller grill can improve heating uniformity. However, it has also been found that rolling can adversely affect the structural quality of the food product by breaking down the shell and/or drying portions of the food product that may have less innate structural stability or flexibility than, for example, a hot dog. A need exists, therefore, for a variety of grab-and-go food products that may retain their integrity and textural appeal during heating with a roller heating device, for example, that moves the product as it is being heated. A need also exists, for a variety of grab-and-go food products that may retain their integrity during consumption.

### BRIEF SUMMARY OF THE INVENTION

The present disclosure relates to novel and advantageous food products comprising, a filling and a starch layer surrounding the filling. The food product also includes a batter and breading layer surrounding the starch layer, wherein the food product is cylindrically shaped, and wherein the food product maintains its shape when the food product is held at one end.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 is a cross-sectional view of a food product of the present disclosure, according to one embodiment.

FIG. 2 shows a process for making a food product of the present disclosure, according to one embodiment.

### DETAILED DESCRIPTION

The present disclosure relates to novel and advantageous food products, such as filled sticks or bites and methods of making the same, which are packaged for a grab-and-go sales environment, and to a method for heating such products to an eating temperature without degrading the quality of the product.

The embodiments described herein and the various features and advantages of the embodiments are explained more fully with reference to the non-limiting embodiments that are illustrated in the accompanying drawings and detailed in the following description. Descriptions of well-known components and processes and manufacturing techniques are omitted so as to not unnecessarily obscure the embodiments herein. The examples used herein are intended merely to facilitate an understanding of ways in which the embodiments disclosed herein may be practiced and to further enable those of skill in the art to practice the embodiments described. Accordingly, the examples provided should not be construed as limiting the scope of the claimed invention.

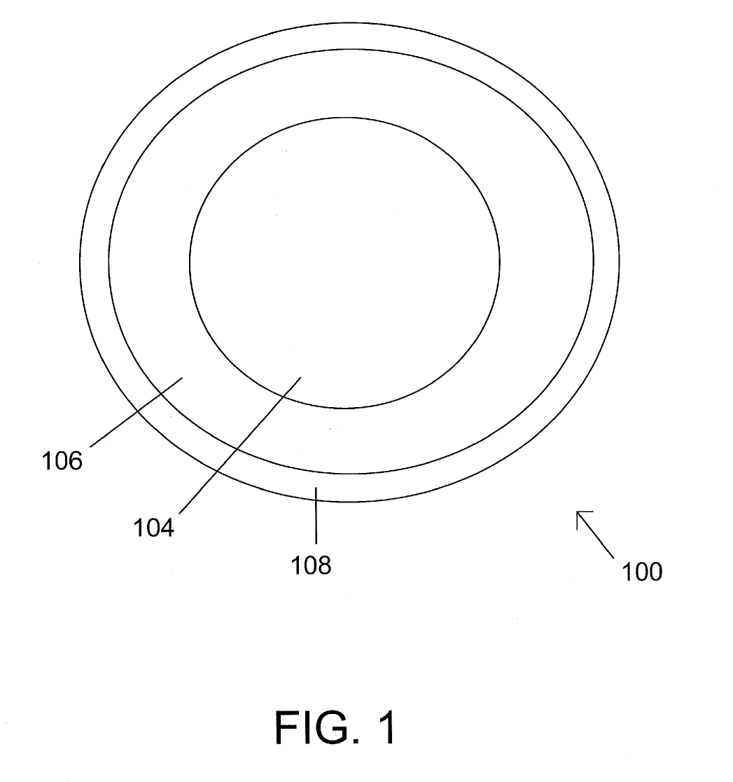

In one embodiment of the present invention, a food product may be comprised of a plurality of layers surrounding a filling. As may be seen in FIG. 1, moving from the inside of the food product 100 to the outside, a filling 104 may be surrounded by a starch layer 106. One or more breading layers 108 may surround the starch layer 106. In one embodiment, the food product 100 may be generally cylindrically shaped, having a similar shape as a hot dog, for example. The food product 100 may have any desired circumference that may depend on what filling 104 may be used, and/or what ingredients may be used for the starch layer 106. In some cases, the food product 100 may have a diameter similar to that of a traditional hotdog, while in other cases, the diameter may be smaller than that of a traditional hotdog. In still other embodiments, the diameter may be greater than, or much greater than that of a traditional hotdog. In some embodiments, for example the diameter may be from about ¾ inch to about 1½ inch. More preferably, the diameter may be from about 1⅛ inch to about 1¼ inch. Similarly, the food product 100 may have any suitable length. For example, in some embodiments, the length may be relatively similar to the diameter, resulting in a substantially spherical food product 100. The diameter of a generally spherical food product 100 may be from about 1½ inches wide to about 1 inch long. One advantage of some embodiments of the present disclosure is that the food product 100 may have a certain degree of structural stability that may allow the food product 100 to maintain a relatively rigid shape during consumption. In such embodiments, the food product 100 may not generally bend, sag, fold, or otherwise lose its generally cylindrical, straight shape when the food product 100 is raised, moved, or held, for example, at one end such as when the food product 100 is being eaten. In such embodiments, there may be a practical limitation on how long the food product 100 may be, but generally speaking there is no limitation on the length of the food product 100.

The filling 104 of the food product 100 may generally be any suitable edible material. In some embodiments, the filling may be selected such that the flavor and taste of the food product 100 is best when cooked and/or eaten hot. Some non-limiting examples of fillings include: buffalo chicken; pizza; sloppy joe mix; hamburger; cheeseburger; fajita; smothered steak; Italian (e.g. pepperoni, salami, ham, cheese); chicken bacon ranch; sausage, peppers and onions; turkey club; barbeque pork; honey mustard chicken; chipotle flavored filling; Philly cheese steak; ham and swiss; chicken pesto; beef, bacon and cheddar; asiago chicken; chili; breakfast skillet (e.g. egg, sausage, cheese, onions, and peppers); loaded potato (e.g. bacon, cheddar, cream cheese and green onions); macaroni and cheese; jalapeno cheddar; or any other desired filling; and/or combination of fillings. The filling may be suitable in some embodiments to be eaten for breakfast, while in other embodiments, the filling may be suitable to be eaten for lunch, dinner, snacks, and/or desert.

The starch layer 106 may surround the filling 104. In some embodiments the starch layer 106 may be the primary functional layer that provides integrity to the food product 100 during the cooking process, as well as the heating, handling, and eating process. In one embodiment, the starch layer 106 may include a blend of starch, gum, and methocelulose combined with mashed potato. Additives may also be included in some cases, such as additional starch, dairy product(s), seasonings, vitamins, minerals, and/or any other additive that may provide flavor and/or textural attributes, for example. While this layer is referred to as a starch layer 106 herein, it will be understood that in some embodiments starch may not be included in the starch layer 106. The starch layer 106 may include any suitable edible product that may provide integrity to the food product 106, such as, but not limited to: any suitable starch base; masa; cornmeal; short-grain rice; polenta; sticky/sushi rice; small pasta (e.g. acini de pepe, orzo); mashed vegetables (e.g. broccoli, cauliflower, carrot, rutabaga, parsnip, turnip, peas, spinach); arborio rice/risotto; grits; sweet potato/yam; red skin potatoes, or any other potato variety; plantain; couscous; bulgar wheat; quinoa; millet; oatmeal; tapioca; semolina; hushpuppy; granola/meusli; gelatin/jell-o; cream cheese; mousse; pudding; fruit; cheese; or any other suitable ingredient, or combination of ingredients. In addition to the aforementioned ingredients being used in the starch layer 106, in some embodiments, some of the ingredients, or a combination of the ingredients may be used, or may also be used as a filling 104.

The breading layer(s) 108 may include a batter and/or breading. For example, in some embodiments, a pre-made batter and/or breading may be used, while in other embodiments any suitable batter and/or breading may be used. The batter and/or breading layer may also include spices, nuts, vitamins, minerals, and/or any other ingredients that my add flavor and/or texture.

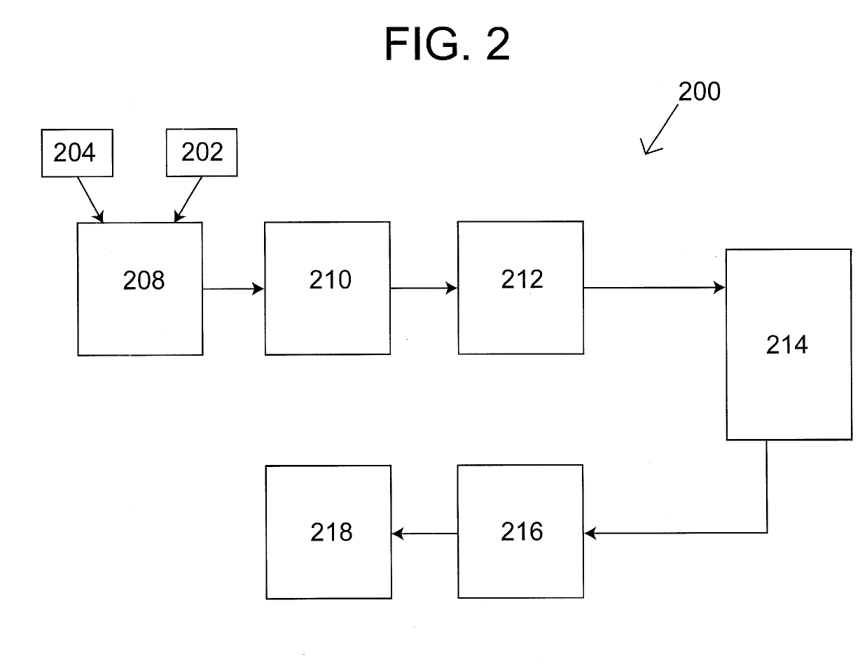

The food product 100 of the present disclosure in some embodiments may be made by the process 200 shown in FIG. 2. The process 200 may generally be a continuous process in some embodiments, while in other embodiments, the process 200 may occur in steps. The filling 202 and the ingredients comprising the starch layer 204 may be fed to a co-extruder 208, such that after being co-extruded, the filling 202 may be generally encapsulated within the outer starch layer 204. The starch layer may be any suitable thickness. For example, in some embodiments of a food product that is generally cylindrically shaped, the starch layer may have a thickness of from about 0.09 to about 0.19 inch thick. In still other embodiments, the starch layer may have a thickness of from about 0.110 to about 0.150 inch. For embodiments of food products that are generally spherically shaped, the starch layer may have a thickness of from about 0.07 to about 0.2 inch. In still other embodiments, a spherically-shaped food product may have a thickness of from about 0.090 to about 0.150 inch. The co-extruded product may then proceed to a batter station 210 where the product may be coated and/or sprayed with a wet batter. Following the batter station, the product may then be coated with breading at the breading station 212. The generally dry breading may readily adhere to the wet batter coating the product. In some embodiments, the food product may have a batter/breading thickness of from about 0.08 to about 0.18 inch. In still other embodiments, the food product may have a batter/breading thickness of from about 0.100 to about 0.140 inch. In some embodiments, the product may process through the batter 210 and breading 212 stations one time, while in other embodiments, the product may go through the batter 210 and breading 212 stations two or more times. It may be advantageous, in some embodiments, for the product to process through the batter 210 and breading 212 stations at least two times to provide additional integrity to the food product. In some embodiments, the batter and breading may be combined.

Following the batter and breading process 210, 212, the product may be processed through a roller 214 that may shape the product into a desired shape, whether that shape is generally cylindrical or spherical. After the product has been suitably shaped in the roller 214, the product may be cooked in a fryer 216. In some embodiments, the potato base layer may be activated by heat. Accordingly, the cooking temperature in some embodiments may desirably be at least 185 degrees Fahrenheit in order to allow the starch layer to serve as a structural support layer for the food product. The product may be heated a suitable amount of time to ensure that the ingredients are properly cooked. Following heating/cooking, the food product may be packaged and/or frozen 218. The frozen food product may then be shipped to stores, restaurants or other consumers or establishments.

In one embodiment, the finished food product may have the following approximate composition by percentage of total weight: starch layer 26%; filling 42%; batter 22%; crumb/seasoning blend 8%; fry oil 2%. The foregoing percentages may be altered in other embodiments without departing from the general spirit and scope of the present disclosure, but the foregoing percentages of ingredients in combination with the foregoing process for making the food product have been shown to result in a food product that may withstand heating and handling without the food product losing its general shape and structural integrity. One advantage of some embodiments of the present disclosure may be that the food product may be warmed and/or heated on a roller grill that may traditionally be used for cooking and/or warming hotdogs, for example, at convenience stores, bowling alleys, bars, amusement parks, carnivals, parades, etc. Accordingly, the food products of the present disclosure may be sold wherever hotdogs warmed and/or cooked on roller grills may be sold, thereby offering a wider variety of grab-and-go food products to consumers. It will be understood, however, that while some embodiments of food products of the present disclosure may be heated on roller grills, other embodiments may be packaged so that the food product may be heated in the microwave, in the oven, or on the stove top, for example.

Although the present invention has been described with reference to preferred embodiments, persons skilled in the art will recognize that changes may be made in form and detail without departing from the spirit and scope of the invention.

What is claimed is:

1. A food product comprising:
a filling;
a starch layer surrounding the filling; and
a batter and breading layer surrounding the starch layer, wherein the food product is substantially cylindrically shaped, and wherein the food product maintains its shape when the food product is held.

2. The food product of claim 1, the starch layer having a thickness from about 0.09 to about 0.19 inch.

3. The food product of claim 2, wherein the diameter of the food product is from about ¾ inch to about 1½ inch.

4. The food product of claim 3, wherein there are two or more layers of batter and breading.

5. The food product of claim 4, the batter and breading layer having a thickness from about 0.08 to about 0.18 inch.

6. The food product of claim 5, further comprising fry oil.

7. The food product of claim 6, wherein the food product has the following approximate percentages by weight of the entire product, 26% starch layer, 42% filling, 30% batter and breading, and 2% fry oil.

8. The food product of claim 7, wherein the food product is cylindrically shaped.

9. The food product of claim 7, wherein the food product is spherically shaped.

10. A method of making a food product, the method comprising:
co-extruding a filling and a starch layer, such that the filling is encapsulated in the starch layer;
spraying the co-extruded product with a wet batter;
coating the co-extruded product with the wet batter with a breading;
shaping the co-extruded product with the batter and breading on a roller to form a cylindrically shaped product;
cooking the cylindrically shaped product in a fryer; and
freezing the fried product.

11. The method of claim 10, further comprising spraying the bread coated product with another layer of wet batter and coating the wet batter with another layer of breading.

12. The method of claim 11, wherein the cylindrically shaped product is cooked in the fryer at a temperature of at least about 185° F.

13. The method of claim 12, further comprising packaging the food product.

14. The method of claim 13, wherein the filling includes a meat product.

15. The method of claim 14, wherein the filling further includes a cheese product.

16. A food product for warming on a roller grill, the food product comprising:
a filling;
a starch layer surrounding the filling; and
a batter and breading layer surrounding the starch layer, the batter and breading layer including at least one of a flavor or texture enhancer,
wherein the food product is substantially cylindrically shaped, and wherein the food product maintains its shape when the food product is held.

17. The food product of claim 16, wherein the starch layer includes potato.

18. The food product of claim 17, wherein the filling includes a cheese product.

19. The food product of claim 18, wherein the filling also includes a meat product.

20. The food product of claim 19, wherein the filling also includes a vegetable.
